(19) United States
(12) Patent Application Publication
(10) Pub. No.: US 2010/0094527 A1
(43) Pub. Date: Apr. 15, 2010

(54) CONTROL SYSTEM FOR INTERNAL COMBUSTION ENGINE AND CONTROL METHOD THEREFOR

(76) Inventors: Yoshinori Futonagane, Shizuoka-ken (JP); Kazuhiro Omae, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/516,455

(22) PCT Filed: Jun. 20, 2008
(86) PCT No.: PCT/IB08/01632

§ 371 Date: May 27, 2009

(30) Foreign Application Priority Data
Jun. 21, 2007 (JP) 2007-163838

(51) Int. Cl. F02D 41/30; F02M 7/00

(52) U.S. Cl. 701/103; 123/435; 123/436

(57) ABSTRACT

The temperature at the tip of a fuel injection valve (31) is estimated based on first to third parameters. The first parameter is a parameter that indicates the combustion temperature, such as the fuel injection amount and the combustion timing. The second parameter is a parameter that indicates the heat exposure timing and the heat exposure time. Examples of the second parameter include the engine speed and the combustion timing. The third parameter is a parameter that indicates the temperature increase of the fuel along with a decrease in pressure of the fuel at the injection hole (31b, 31c), such as the pressure of the fuel in the fuel injection device (3).

### BACKGROUND OF THE INVENTION

1. Field of the Invention

The present invention relates to a control device for an internal combustion engine (hereinafter referred to simply as “control device”) including a fuel injection device that injects fuel into a combustion chamber from an injection hole provided at the tip of a fuel injection valve, and to a method of controlling the fuel injection valve.

2. Description of the Related Art

Devices of this type are described in Japanese Patent Application Publication No. 2003-227375 (JP-A-2003-227375) and Japanese Patent Application Publication No. 2006-57538 (JP-A-2006-57538), for example. These devices estimate the state of deposits generated in the vicinity of the injection hole based on the temperature at the tip of the fuel injection valve (injector).

The term “ deposits” as used herein refers to deposits of carbide, oxide, etc. Deposits are generated when unburned fuel is carbonized when, for example, a flame and/or high heat is generated as a result of fuel combustion in the combustion chamber.

In the device described in JP-A-2003-227375, the accumulated deposit amount is estimated based on the temperature detected by a temperature sensor at the tip of a fuel injection valve, or the engine coolant temperature or the intake air amount, which are each a parameter associated with the tip temperature. In the device described in JP-A-2006-57538, the temperature at the tip of a fuel injection valve is obtained using a map based on the engine speed and the load factor, and the obtained tip temperature is used to estimate the accumulated deposit amount.

It is necessary for the devices of this type to more accurately estimate the generation state of deposits in order to more appropriately control the operation of the internal combustion engine.

### SUMMARY OF THE INVENTION

The present invention provides a control device that more accurately estimates the generation state of deposits at an injection hole by more accurately estimating the temperature at the tip of a fuel injection valve, and provides a method of controlling the fuel injection valve.

A first aspect of the present invention is directed to a control device that controls the operation of an internal combustion engine including a fuel injection device. The fuel injection device includes a fuel injection valve. An injection hole is provided at the tip of the fuel injection valve. The fuel injection device injects fuel from the injection hole into a combustion chamber. Specifically, the fuel injection device may be disposed such that the injection hole is exposed into the combustion chamber. That is, the fuel injection device may be configured and disposed such that fuel is directly injected from the injection hole into the combustion chamber.

The control device in accordance with first aspect is characterized by including a first parameter acquisition section (first parameter acquisition means), a second parameter acquisition section (second parameter acquisition means), a third parameter acquisition section (third parameter acquisition means), and a temperature estimation section (temperature estimation means).

The first parameter acquisition section acquires a first parameter. The first parameter corresponds to a combustion temperature when fuel is combusted in the combustion chamber. Examples of the first parameter include the fuel injection amount and the combustion timing.

The second parameter acquisition section acquires a second parameter. The second parameter corresponds to a heat exposure timing at which the tip of the fuel injection valve is exposed to heat produced by the combustion of the fuel and a heat exposure time for which the tip of the fuel injection valve is exposed to the heat produced by the combustion of the fuel. Examples of the second parameter include the engine speed and the combustion timing.

Here, various parameters related to the combustion timing (at least one of an engine speed, a fuel injection amount, an intake air temperature, an engine coolant temperature, a fuel injection pressure, a fuel injection timing, an in-cylinder oxygen concentration, and a charging pressure) may be used as the first parameter and/or the second parameter.

The third parameter acquisition section acquires a third parameter. The third parameter corresponds to a temperature increase of the fuel along with a decrease in pressure of the fuel at the injection hole. Examples of the third parameter include the pressure of the fuel in the fuel injection device.

The temperature estimation section estimates a temperature at the tip of the fuel injection valve (hereinafter referred to simply as “nozzle temperature”) based on the first to third parameters.

According to such a configuration, the nozzle temperature may be more accurately estimated based on the first to third parameters. The first to third parameters have been used for operation control of conventional internal combustion engines.

Therefore, according to such a configuration, the nozzle temperature may be more accurately acquired (estimated) without using a special sensor or parameter for estimation of the nozzle temperature. Thus, the generation state of deposits at the injection hole may be more accurately estimated.

In the control device in accordance with the first aspect, a condition for injection of the fuel may be controlled such that the temperature at the tip of the fuel injection valve is lowered when an estimated temperature obtained by the temperature estimation section remains at a predetermined temperature or more for at least predetermined time, for example. Thus, the nozzle temperature is effectively restrained from being excessively high. This effectively restrains strong fixation of deposits or deterioration at the tip (such as wearing of a seat portion of a housing (occasionally referred to as “nozzle body”)). This also effectively restrains the precision of fuel injection amount control from lowering.

A second aspect of the present invention is directed to a control method for an internal combustion engine including a fuel injection device that injects fuel into a combustion chamber from an injection hole provided at a tip of a fuel injection valve. The control method includes: acquiring a first parameter that indicates a combustion temperature when the fuel is combusted in the combustion chamber; acquiring a second parameter that indicates a heat exposure timing at which the tip of the fuel injection valve is exposed to heat produced by the combustion of the fuel and a heat exposure time for which the tip of the fuel injection valve is exposed to the heat produced by the combustion of the fuel; acquiring a third parameter that indicates a temperature increase of the fuel along with a decrease in pressure of the fuel at the injection hole; and estimating the temperature at the tip of the fuel injection valve based on the first to third parameters.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram showing the overall configuration of an embodiment of the present invention;

FIG. 2A, FIG. 2B, and FIG. 2C are each a side cross sectional view showing as enlarged the tip of the nozzle shown in FIG. 1;

FIG. 3 is a graph of experimental results showing the influence of the particle amount on the degree of blockage at a second injection hole;

FIG. 4 is a flowchart illustrating a specific example of the operation to estimate the adhesion state of deposits in accordance with this embodiment;

FIG. 5 is a flowchart illustrating a specific example of the estimation of the nozzle temperature in accordance with this embodiment;

FIG. 6 is a flowchart illustrating a specific example of the nozzle temperature adjustment process in accordance with this embodiment; and

FIG. 7 is a soot map that is used the operation to estimate the adhesion state of deposits in accordance with a modification.

### DETAILED DESCRIPTION OF EMBODIMENTS

A description will hereinafter be made of an embodiment of the present invention with reference to the drawings.

It should be noted that the description below is merely an illustration as specific as possible of an embodiment of the present invention. Therefore, as discussed later, the present invention should not be limited in any way to the specific configurations of the embodiment described below. Various modifications that may be made to the embodiment will be collectively described at the end of the specification, in order to avoid such descriptions from interrupting a comprehensive understanding of the description of the embodiment by providing them in the course of the description of the embodiment.

### Overall System Configuration

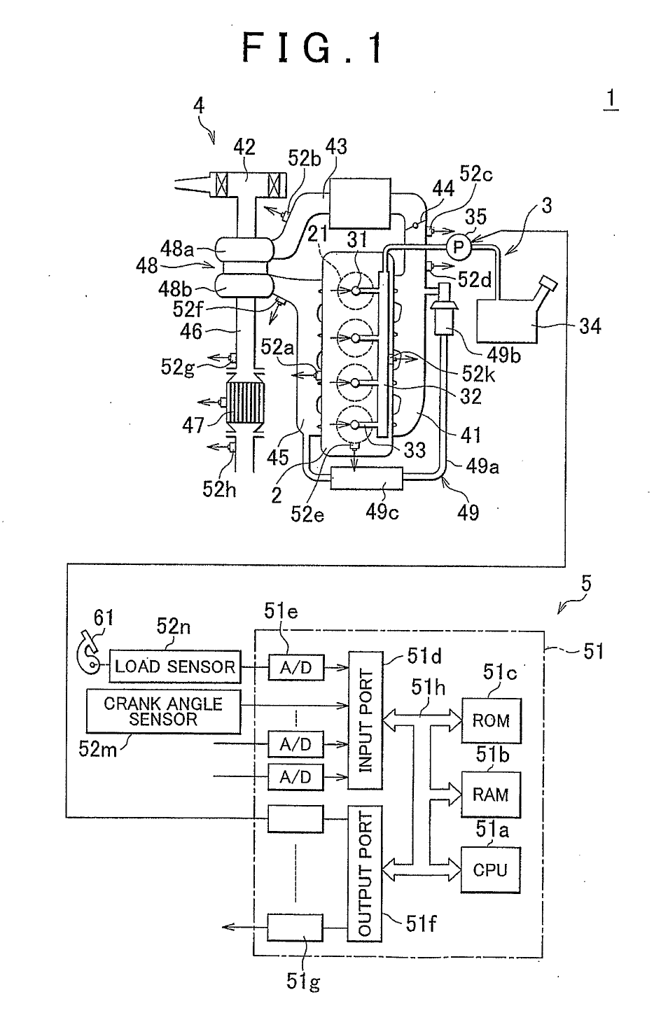

FIG. 1 is a schematic diagram showing the overall configuration of an engine control system 1 according to the present invention.

Referring to FIG. 1, the engine control system 1 includes an engine 2, a fuel injection device 3, an intake/exhaust device 4, and an engine control device 5. In this embodiment, the engine 2 includes a plurality of combustion chambers 21 arranged in series with each other. The engine 2 in accordance with this embodiment is a so-called auto-ignition engine (which includes diesel engines).

Fuel Injection Device

The fuel injection device 3 includes a plurality of fuel injection valves 31 provided in the same number as that of the combustion chambers 21. The fuel injection valves 31 of this embodiment are fuel injection nozzles of a known piezo type. Each fuel injection valve 31 is disposed for each combustion chamber 21.

The fuel injection valve 31 is provided with its tip exposed into each combustion chamber 21. That is, the fuel injection device 3 directly injects fuel into the combustion chamber 21 from the tip of the fuel injection valve 31 exposed into the combustion chamber 21.

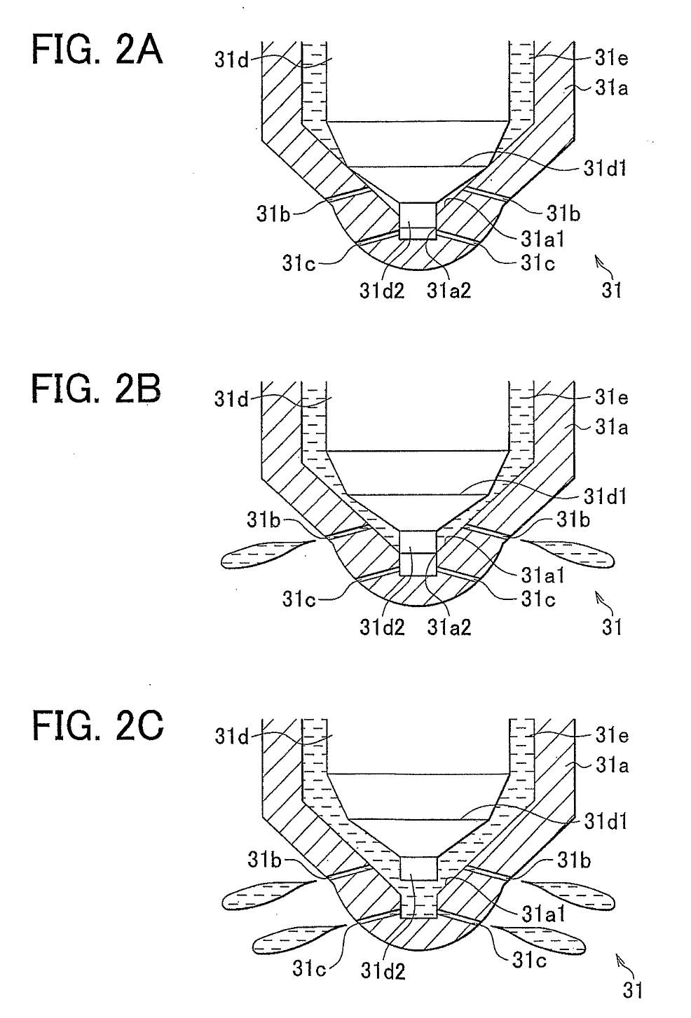

FIG. 2A to FIG. 2C are each a side cross sectional view showing as enlarged the tip of the fuel injection valve 31 shown in FIG. 1. Referring to FIG. 2A, a housing 31a, which constitutes the main body of the fuel injection valve 31, is constituted of a tubular member with a closed tip. The closed tip of the housing 31a is generally formed in the shape of an inverted cone. A first seat portion 31a1 and a second seat portion 31a2 are provided at the tip of the housing 31a generally in the shape of an inverted cone.

The first seat portion 31a1 is formed as the inner side surface of a truncated conical depression, with its tip (lower end in the drawing) connected to the second seat portion 31a2. The second seat portion 31a2 is formed as the inner surface of a generally cylindrical shape, with its tip (lower end in the drawing) blocked by the extreme tip of the housing 31a. The first seat portion 31a1 and the second seat portion 31a2 are provided to form a depression inside the housing 31a.

At the tip of the housing 31a generally in the shape of an inverted cone are formed a first injection hole 31b and a second injection hole 31c. The first injection hole 31b and the second injection hole 31c are each formed as a through hole that communicates the tip of the space inside the housing 31a and the space outside it. That is, the fuel injection device 3 injects fuel into the combustion chamber 21 (see FIG. 1) from the first injection hole 31b and the second injection hole 31c exposed to the combustion chamber 21 (see FIG. 1).

In this embodiment, the second injection hole 31c is provided closer to the tip of the housing 31a (closer to the lower end in the drawing) than the first injection hole 31b is. Specifically, in this embodiment, the first injection hole 31b is provided close to the tip of the first seat portion 31a1 (close to the lower end in the drawing). Meanwhile, the second injection hole 31c is provided at a position corresponding to the lower end of the second seat portion 31a2. That is, the second injection hole 31c is provided at the extreme tip of the housing 31a.

In this embodiment, a plurality of first injection holes 31b are formed to extend in radial directions and at equal angular intervals as viewed in plan from the central axis of the housing 31a extending vertically in the drawing. As with the first injection holes 31b, a plurality of second injection holes 31c are formed to extend in radial directions and at equal angles.

Inside the housing 31a is accommodated a needle valve 31d so as to be movable axially (vertically in the drawing). The needle valve 31d is constituted of a long and thin bar-like member. The tip of the needle valve 31d is formed in a shape obtained by joining a first inverted truncated cone with a large conical angle, a second inverted truncated cone with a small conical angle, and a column in this order.

A first seat contact portion 31d1 is provided at the tip of the needle valve 31d at the position where the first inverted truncated cone and the second inverted truncated cone are connected. The first seat contact portion 31d1 is formed as a circular edge projecting outward so as to be able to liquid-tightly contact the first seat portion 31a1 over its entire periphery.

That is, the first seat contact portion 31d1 is formed to interrupt the communication between the first injection hole 31b or the second injection hole 31c and a fuel passage 31e (the space between a portion of the housing 31a upstream, in the fuel supply direction, of its tip generally in the shape of an inverted cone and a portion of the needle valve 31d upstream of the first seat contact portion 31d1) as the first seat contact portion 31d1 contacts the first seat portion 31a1.

A second injection hole block portion 31d2 is provided at the extreme tip of the needle valve 31d. The second injection hole block portion 31d2 is the cylindrical portion at the tip of the needle valve 31d discussed above, and interrupts the communication between the generally cylindrical depression formed by the second seat portion 31a2 and the second injection hole 31c as the second injection hole block portion 31d2 is fitted into the depression.

In addition, the fuel injection valve 31 in accordance with this embodiment is configured to be in the state where the first injection hole 31b and the fuel passage 31e are communicated with each other and the communication between the second injection hole 31c and the fuel passage 31e are interrupted (see FIG. 2B), or in the state where the first injection hole 31b, the second injection hole 31c, and the fuel passage 31e are communicated with each other (see FIG. 2C), according to the lifting state (lift amount) of the needle valve 31d.

That is, in this embodiment, the fuel injection device 31 is configured to switchably perform first fuel injection in which the first injection hole 31b is used but not the second injection hole 31c (see FIG. 2B), and second fuel injection in which the first injection hole 31b and the second injection hole 31c are used (see FIG. 2C), according to the operating conditions such as the load and the fuel injection amount.

Referring again to FIG. 1, the fuel injection device 3 is of a known common rail type, in which each fuel injection valve 31 is connected to a common rail 32 via a fuel supply pipe 33. A fuel pump 35 is provided in a fuel supply passage between the common rail 32 and a fuel tank 34.

### Intake/Exhaust Device

In order to be able to supply air (containing recirculated exhaust gas) to the combustion chamber 21 of the engine 2, to discharge exhaust gas from the combustion chamber 21, and to purify the exhaust gas, the intake/exhaust device 4 is configured as follows.

An intake manifold 41 is mounted on the engine 2 to supply air to each combustion chamber 21. The intake manifold 41 is connected to an air cleaner 42 via an intake pipe 43. A throttle valve 44 is provided in the intake pipe 43.

An exhaust manifold 45, which constitutes the exhaust passage of this embodiment, is mounted on the engine 2 to receive exhaust gas from each combustion chamber 21. The exhaust manifold 45 is connected to an exhaust pipe 46. A catalyst filter 47 is provided in the exhaust pipe 46, which constitutes the exhaust passage of this embodiment.

The catalyst filter 47 in accordance with this embodiment not only purifies three components, namely HC, CO, and NOx, in the exhaust gas, but also function as a particle filter that collects suspended carbon particles (hereinafter referred to simply as “particles”) in the exhaust gas. Further, the catalyst filter 47 may be regenerated, that is, have a regeneration function of receiving a supply of hot exhaust gas to oxidize the collected particles into carbon dioxide.

A turbocharger 48 is provided between the intake pipe 43 and the exhaust pipe 46. That is, the intake pipe 43 is connected to a compressor 48a side of the turbocharger 48, and the exhaust pipe 46 is connected to a turbine 48b side of the turbocharger 48.

An EGR device 49 is provided between the intake manifold 41 and the exhaust manifold 45. Here, the term “EGR” is an abbreviation for “exhaust gas recirculation.” The EGR device 49 includes an EGR passage 49a, a control valve 49b, and an EGR cooler 49c.

The EGR passage 49a is a passage for recirculated exhaust gas (EGR gas), and connects the intake manifold 41 and the exhaust manifold 45. The control valve 49b and the EGR cooler 49c are provided in the EGR passage 49a. The control valve 49b is configured and disposed to control the amount of EGR gas that is supplied to the intake manifold 41. The EGR cooler 49c cools the EGR gas using the coolant of the engine 2.

### Engine Control Device

The engine control device 5 as the control device of the present invention controls the operation of an engine that includes the fuel injection device 3.

The engine control device 5 includes an electronic control unit (ECU) 51. The ECU 51 includes a microprocessor (CPU) 51a, a random access memory (RAM) 51b, a read only memory (ROM) 51c, an input port 51d, an A/D converter 51e, an output port 51f, a driver 51g, and a bidirectional bus 51h.

The CPU 51a, which constitutes the first parameter acquisition section (first parameter acquisition means), the second parameter acquisition section (second parameter acquisition means), the third parameter acquisition section (third parameter acquisition means), and the temperature estimation section (temperature estimation means) of the present invention, executes routines (programs) for controlling the operation of respective parts in the engine control system 1.

The RAM 51b temporarily stores data as necessary while the CPU 51a is executing the routines. The ROM 51c preliminarily stores the routines (programs) discussed above, and tables (lookup tables and maps), parameters, and so forth to be referenced while the routines are being executed.

The input port 51d is connected via the A/D converter 51e to various sensors in the engine control system 1 to be discussed later. The output port 51f is connected via the driver 51g to respective parts in the engine control system 1 (such as the fuel injection valve 31). The CPU 51a, the RAM 51b, the ROM 51c, the input port 51d, and the output port 51f are connected to each other via the bidirectional bus 51h.

An engine coolant temperature sensor 52a, a charging pressure sensor 52b, an airflow meter 52c, an intake air temperature sensor 52d, an in-cylinder pressure sensor 52e, a smoke sensor 52f, an upstream air-fuel ratio sensor 52g, a downstream air-fuel ratio sensor 52h, a common rail pressure sensor 52k, a crank angle sensor 52m, and a load sensor 52n, are each connected to the input port 51d of the ECU 51 via the A/D converter 51e.

The engine coolant temperature sensor 52a, which constitutes the first parameter acquisition section (first parameter acquisition means) and the second parameter acquisition section (second parameter acquisition means) of the present invention, is mounted in the engine 2. The engine coolant temperature sensor 52a generates an output voltage in accordance with the engine coolant temperature Thw.

The charging pressure sensor 52b, which constitutes the first parameter acquisition section (first parameter acquisition means) and the second parameter acquisition section (second parameter acquisition means) of the present invention, is provided in the intake pipe 43. The charging pressure sensor 52b generates an output voltage in accordance with the charging pressure Pc.

The airflow meter 52c, which constitutes the first parameter acquisition section (first parameter acquisition means) and the second parameter acquisition section (second parameter acquisition means) of the present invention, is provided in the intake pipe 43. The airflow meter 52c generates an output voltage in accordance with the mass flow rate of intake air flowing in the intake pipe 43 per unit time (intake air flow rate Ga).

The intake air temperature sensor 52d, which constitutes the first parameter acquisition section (first parameter acquisition means) and the second parameter acquisition section (second parameter acquisition means) of the present invention, is provided in the intake pipe 43. The intake air temperature sensor 52d generates an output voltage in accordance with the temperature of intake air flowing in the intake pipe 43 (intake air temperature Ti).

The in-cylinder pressure sensor 52e is mounted to the engine 2. The in-cylinder pressure sensor 52e generates an output voltage in accordance with an in-cylinder pressure Ps.

The smoke sensor 52f is provided in the exhaust manifold 45. The smoke sensor 52f generates an output voltage corresponding to the particle amount Qp in the exhaust gas discharged after combustion from the combustion chamber 21 into the exhaust manifold 45.

The upstream air-fuel ratio sensor 52g is provided in the exhaust pipe 46 at a location upstream of the catalyst filter 47 in the flowing direction of the exhaust gas. The upstream air-fuel ratio sensor 52g is a current limit-type oxygen concentration sensor that precisely senses the air-fuel ratio over a wide range, and produces an output voltage corresponding to the air-fuel ratio afr.

The downstream air-fuel ratio sensor 52h is provided in the exhaust pipe 46 at a location downstream of the catalyst filter 47 in the flowing direction of the exhaust gas. The downstream air-fuel ratio sensor 52h is an electromotive force-type (concentration cell-type) oxygen concentration sensor, and configured to make an output voltage that changes abruptly around the theoretical air fuel ratio.

The common rail pressure sensor 52k, which constitutes the first parameter acquisition section (first parameter acquisition means), the second parameter acquisition section (second parameter acquisition means), and the third parameter acquisition section (third parameter acquisition means) of the present invention, is provided in the common rail 32. The common rail pressure sensor 52k produces an output voltage corresponding to the common rail pressure Pcr, which is the pressure inside the common rail 32.

The crank angle sensor 52m, which constitutes the first parameter acquisition section (first parameter acquisition means) and the second parameter acquisition section (second parameter acquisition means) of the present invention, outputs a narrow pulse each time the crankshaft (not shown) of the engine 2 rotates through a predetermined angle (for example, 10°), and outputs a wide pulse each time the crankshaft rotates through 360°. The engine speed NE is obtained based on the output of the crank angle sensor 52m.

The load sensor 52n is an accelerator operation amount sensor, and generates an output voltage in accordance with the operation amount Accp of an accelerator pedal 61.

### Outline of Estimation of Deposit Adhesion State in Embodiment

The outline of the estimation of the adhesion state of deposit (momentary adhered deposit amount and accumulated deposit amount) in accordance with the embodiment is described below with reference to the drawings.

The fuel injection device 3 of this embodiment switchably performs a first fuel injection, in which fuel is injected through only the first injection hole 31b (see FIG. 2B), and a second fuel injection in which fuel is injected through both the first injection hole 31b and the second injection hole 31c (see FIG. 2C), according to the operating conditions. That is, in this embodiment, the second injection hole 31c is used less frequently than the first injection hole 31b.

Therefore, deposit tends to adhere/accumulate in and around the second injection hole 31c when the first fuel injection, that is, the state where fuel is not injected from the second injection hole 31c, continues for a certain period.

Thus, in this embodiment, the momentary adhered deposit amount and the accumulated deposit amount at the second injection hole 31c are estimated as described below.

The adhesion/accumulation of deposit at the second injection hole 31c is considered to occur as follows. (1) In the first fuel injection, fuel remains in the generally cylindrical depression formed by the second seat portion 31a2 and also in the second injection hole 31c. In addition, a part of fuel injected from the first injection hole 31b adheres around the outside opening (opening facing the combustion chamber 21) of the second injection hole 31c. Deposit is formed by a product from a reaction such as incomplete combustion of unburned fuel and an impurity precipitated by volatilization of such unburned fuel. (2) The area in the vicinity of the second injection hole 31c is exposed to gas generated after combustion in the combustion chamber 21. At this time, particles generated during the combustion of fuel in the combustion chamber 21 adhere inside and in the vicinity of the second injection hole 31c.

Here, the first fuel injection in which fuel is not injected from the second injection hole 31c is performed in the operating region where the load is relatively light. In such an operating region, the temperature in the vicinity of the second injection hole 31c is relatively low.

In this operating region, the main component of deposits is in the form of particles, which “physically” adhere inside and in the vicinity of the second injection hole 31c (there occurs no “chemical” adhesion due to chemical bonding between the deposit and the housing 31a). In this case, the amount of deposits adhering/accumulated at the second injection hole 31c is effectively decreased by fuel injection from the second injection hole 31c.

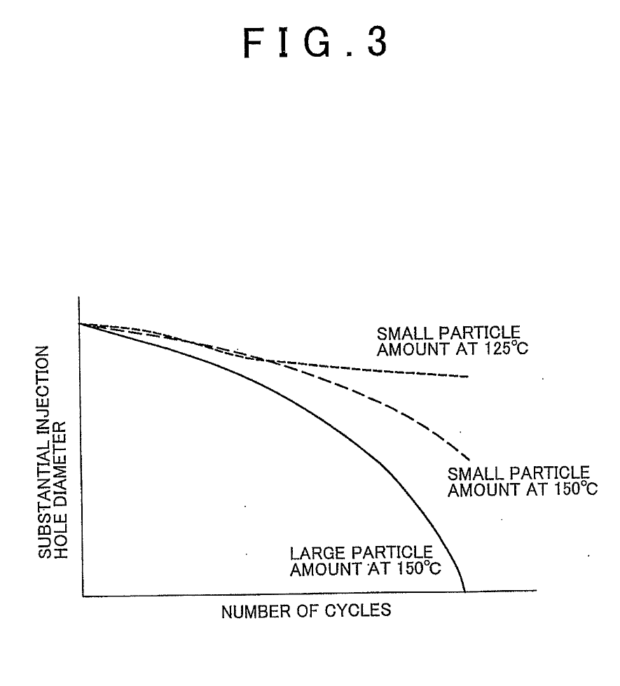

FIG. 3 is a graph of experimental results showing the influence of the particle amount on the degree of blockage at the second injection hole 31c. In FIG. 3, the horizontal axis represents the number of cycles, and the vertical axis represents the substantial injection hole diameter obtained from the injection pressure and the actual injection amount. The temperature indicated in FIG. 3 is the nozzle temperature. As is clear from FIG. 3, in the operating region where the load is relatively light and the nozzle temperature (the temperature in the vicinity of the second injection hole 31c) is low, the degree of blockage at the second injection hole 31c (the degree of decrease in substantial injection hole diameter) is larger as the particle amount is larger. The degree of blockage at the second injection hole 31c is also influenced by the temperature.

Therefore, the momentary adhered deposit amount of deposits in a certain cycle may be expressed as a function of the particle amount. Qp and the nozzle temperature Tnz. In addition, the accumulated deposit amount increases as the number of operating cycles increases unless fuel is injected from the second injection hole 31c. Thus, the amount of accumulated deposits be estimated by integrating the momentary adhered deposit amount discussed above as the first fuel injection is performed in operating cycles.

### Specific Example of Estimation of Deposit Adhesion State in Embodiment

A specific example of the operation to estimate the adhesion state of deposits in accordance with this embodiment is described below with reference to a flowchart.

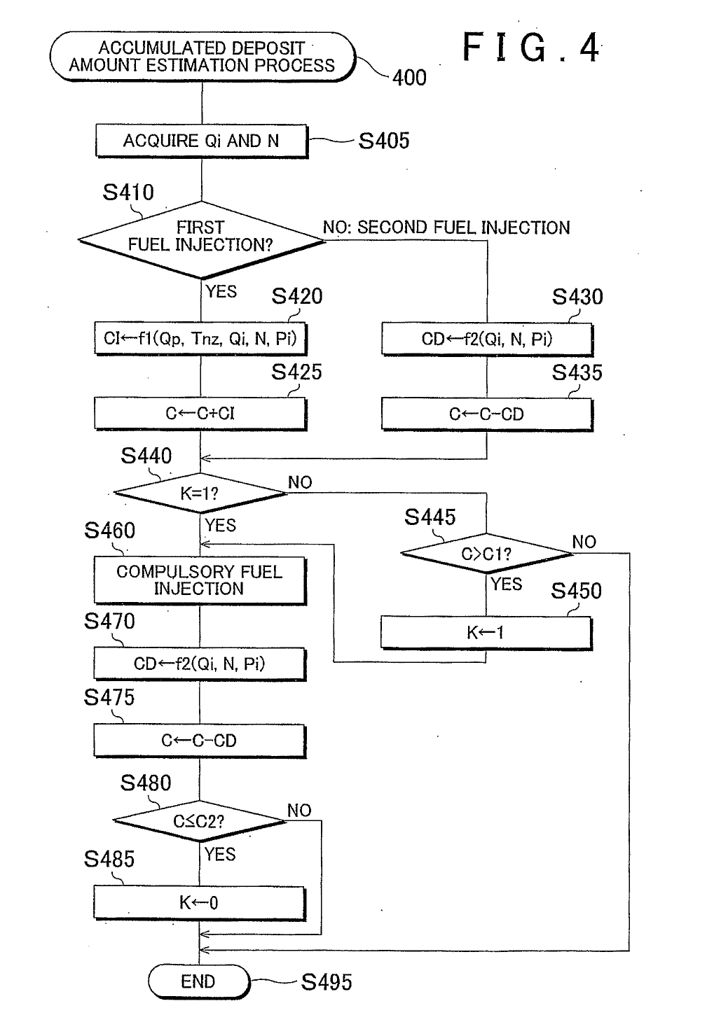

FIG. 4 is a flowchart illustrating the operation discussed above. In the description of the respective steps of the flowchart below, the reference numerals given in FIG. 1, FIG. 2A, FIG. 2B, and FIG. 2C are used as appropriate, and the term “step” is abbreviated as “S.”

The CPU 51a in the ECU 51 executes a accumulated deposit amount estimation routine 400 shown in FIG. 4 repeatedly at predetermined intervals (crank angle).

When the accumulated deposit amount estimation routine 400 is started the current fuel injection amount Qi and the required engine speed N are acquired (S405) based on the output of the load sensor 52n and so forth.

Here, in this specific example, the target fuel injection amount Qt is used as the current fuel injection amount Qi. The target fuel injection amount Qt is the fuel injection amount before feedback correction obtained based on the in-cylinder intake air amount Mc, which is obtained based on the intake air flow rate Ga under the output of the airflow meter 52c, the present engine speed Ne, and a predetermined map, and the required engine speed N and the target air-fuel ratio afrt based on the output of the load sensor 52n. The target fuel injection amount Qt is the sum total of the pilot injection amount Qpilot, the pre injection amount Qpre, the main injection amount Qmain, the after injection amount Qafter, and the post injection amount Qpost.

Next, in S410, it is determined, based on the fuel injection amount Qi, the required engine speed N and the present fuel injection pressure Pi, whether the current fuel injection is the first fuel injection or the second fuel injection. Here, in this specific example, the common rail pressure Pcr is used as the present fuel injection pressure Pi.

If the current fuel injection is the first fuel injection (S410=Yes), an increment amount CI for a counter C that integrates the deposit amount is acquired in S420, and the counter C is incremented in S425. The increment amount CI is acquired using a map based on Qp, Tnz, Qi, N, and Pi (or output signals of the respective sensors corresponding to the physical amounts of these parameters; the same applies hereinafter).

It should be noted that in this specific example, Qp acquired based on the output signal of the smoke sensor 52f is used to acquire the increment amount CI. The acquisition (estimation) of the nozzle temperature Tnz, which is the principal part of this embodiment, will be discussed in detail later.

If the current fuel injection is the second fuel injection (S410=No), a decrement amount CD for the deposit amount counter C is acquired in S430, and the counter C is decremented in S435. The decrement amount CD is acquired using a map based on Qi, N, and Pi.

After the counter C is incremented or decremented in accordance with the determination results of S405, it is determined in S440 whether a compulsory fuel injection execution flag k has been set (1 or 0).

If the compulsory fuel injection execution flag k has not been set (S440=No), it is determined in S445 whether the value of the counter C exceeds a predetermined value C1. If the value of the counter C exceeds the predetermined value C1 (limit deposit amount) (S445=Yes), the compulsory fuel injection execution flag k is set in S450. If the value of the counter C does not exceed the predetermined value C1 (S445=No), the subsequent steps are skipped.

If the compulsory fuel injection execution flag k has been set (S440=Yes), or if the compulsory fuel injection execution flag k is set in S450, compulsory fuel injection using the second injection hole 31c is performed in S460. Then, a decrement amount CD for the deposit amount counter C is acquired based on the conditions for the current compulsory fuel injection in S470, in the same way as in S430, and the counter C is decremented in S475.

Subsequently, in S480, it is determined whether the value of the counter C, after the compulsory fuel injection, is a predetermined value C2 (allowable deposit amount) or less. If the value of the counter C is equal to or below the predetermined value C2 (S480=Yes), the compulsory fuel injection execution flag k is reset (set to 0) in S485. If the value of the counter C exceeds the predetermined value C2 (S480=No), S485 is skipped.

After the processes for the compulsory fuel injection execution flag k and the counter C that integrates the deposit amount are performed and the compulsory fuel injection is performed based on the flag k and the value of the counter C as described above, the process proceeds to S495, where this routine is temporarily suspended.

According to the process of this specific example, the momentary adhered deposit amount and the amount of accumulated deposits at the second injection hole 31c may be acquired or estimated based on the particle amount more accurately. By using the thus acquired or estimated value, control of the compulsory fuel injection is more appropriately performed to clear the accumulated deposits from around the second injection hole 31c.

### Specific Example of Estimation of Nozzle Temperature in Embodiment

A specific example of the acquisition (estimation) of the nozzle temperature Tnz, which is the principal part of this embodiment, will be described in detail below.

As a result of intensive study, the present inventors found the following.
(1) Of the various engine operating parameters, the fuel injection amount Qi [mm³/st], the ignition timing IGT [ATDC], the fuel injection pressure Pi [MPa], and the engine speed NE [rpm] are the most influential on the nozzle temperature Tnz [° C.].
(2) Of these four parameters, the fuel injection amount Qi is the most influential on the nozzle temperature Tnz (the larger Qi is, the higher Tnz is), the ignition timing IGT is the second most influential (the more delayed IGT is, the lower Tnz is), the fuel injection pressure Pi is the second least influential (the higher Pi is, the higher Tnz is), and the engine speed NE is the least influential (the higher NE is, the lower Tnz is; under the same load).
(3) The nozzle temperature Tnz may be obtained by the following equation (a). The correlation coefficient between an estimation value obtained using the equation (a) and an actual measurement value is significantly high (0.95 or more).

Tnz=C1·NE+C2·Qi+C3·IGT+C4·Pi (a)

(where C1 to C4 are each a constant that is different according to the engine specifications)

Here, in this specific example, the ignition timing IGT is estimated by an “ignition model” which uses various parameters that have been used by the ECU 51 for engine control, even without the in-cylinder pressure sensor 52e. The estimation of the ignition timing IGT by the ignition model uses the engine speed NE, the intake air temperature Ti, the fuel injection amount Qi, the engine coolant temperature Thw, the fuel injection pressure Pi, the fuel injection timing IT, the in-cylinder oxygen concentration (intake air flow rate Ga and EGR rate EGRR), and the charging pressure Pc.

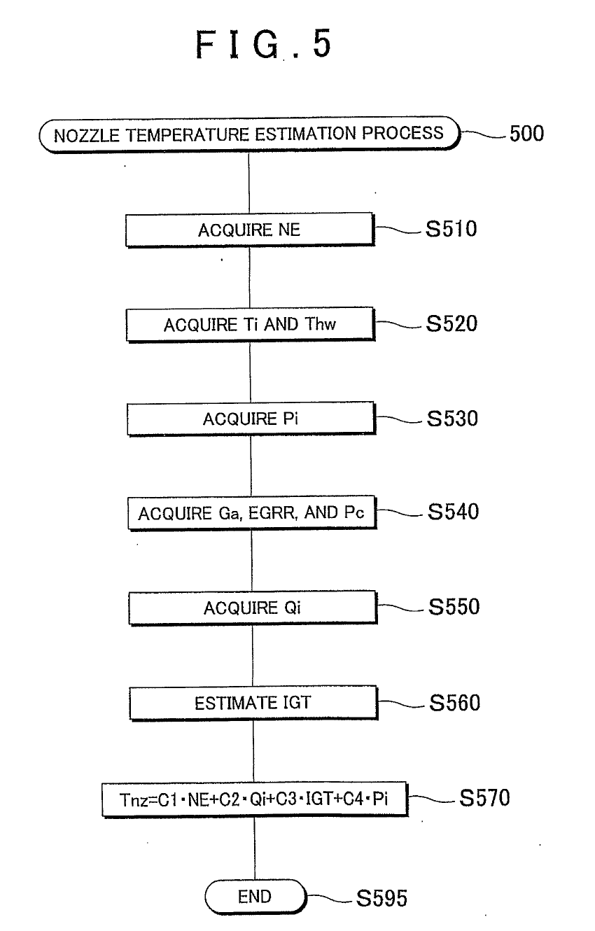

FIG. 5 is a flowchart illustrating an example of the operation discussed above.

The CPU 51a in the ECU 51 executes the nozzle temperature estimation routine 500 shown in FIG. 5 repeatedly at predetermined intervals (crank angle).

When the nozzle temperature estimation routine 500 is started, the engine speed NE is acquired in S510. In S520, the intake air temperature Ti and the engine coolant temperature Thw are acquired. In S530, the common rail pressure Pcr as the fuel injection pressure Pi is acquired. In S540, the intake air flow rate Ga, the EGR rate EGRR, and the charging pressure Pc are acquired.

In S550, the target fuel injection amount Qt as the fuel injection amount Qi is acquired, in the same way as in S405 (see FIG. 4). In S560, the ignition timing IGT is estimated by the ignition model discussed above.

Then, in S570, the nozzle temperature Tnz is estimated based on the equation (a), and this routine is temporarily ended (S595).

As described above, in this specific example, the nozzle temperature Tnz may be accurately estimated by using various parameters that have been used by the ECU 51 for engine control.

It should be noted that the processes in S510 to S550 to acquire the various parameters using the various sensors and the CPU 51a correspond to the first to third parameter acquisition means of the present invention. Also, the process in S570 by the CPU 51a corresponds to the temperature estimation means of the present invention.

### Specific Example of Nozzle Temperature Adjustment

A description will next be made of a specific example of the nozzle temperature adjustment process that restrains the acceleration of fixation (chemical, strong adhesion) of deposits to the tip of the fuel injection valve 31, and deterioration at the tip of the fuel injection valve 31 (such as wearing of the first seat portion 31a1 and the second seat portion 31a2 due to being softened by tempering as a result of being overheated), with reference to a flowchart.

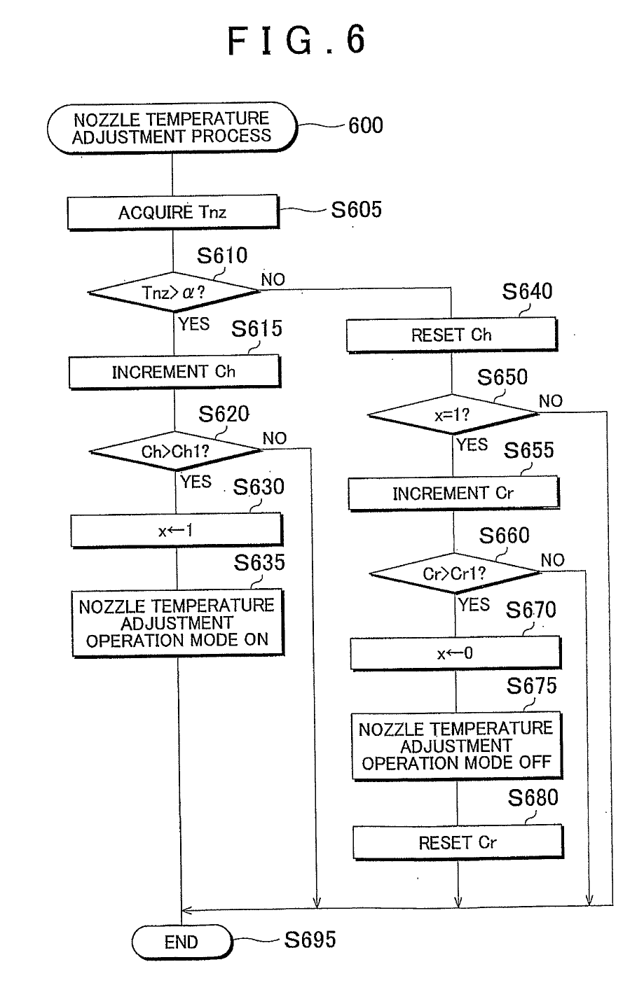

FIG. 6 is a flowchart illustrating the operation.

The CPU 51a in the ECU 51 executes a nozzle temperature adjustment routine 600 shown in FIG. 6 repeatedly at predetermined intervals (crank angle).

When the nozzle temperature adjustment routine 600 is started, first, in S605, the nozzle temperature Tnz is acquired. The nozzle temperature Tnz is acquired in the same way as discussed above. Next, in S610, it is determined whether the nozzle temperature Tnz is more than a predetermined temperature α° C. (for example, 170° C.).

If the nozzle temperature Tnz is more than the predetermined temperature α° C. (S610=Yes), a counter Ch that measures the time for which the nozzle temperature has continued to be high starts incrementing. Subsequently, in S620, it is determined whether the value of the counter Ch is more than a predetermined value Ch1.

If the value of the counter Ch is more than the predetermined value Ch1 (S620=Yes), a nozzle temperature adjustment mode flag x is set in S630, and the engine operating conditions are set to a nozzle temperature adjustment mode in which the nozzle temperature is to be lowered in S635. The nozzle temperature adjustment mode is performed by adjusting at least one of the intake air flow rate Ga, the fuel injection amount Qi, the fuel injection pressure Pi, the ignition timing IGT, the charging pressure Pc, and so forth (such as decreasing Qi or Pi, increasing Ga, and delaying the ignition timing IGT). If the value of the counter Ch is not more than the predetermined value Ch1 (S620=No), S630 and the subsequent steps are skipped.

If the nozzle temperature Tnz is equal to or below the predetermined temperature α° C. (S610=No), the counter Ch is reset in S640. Next, in S650, it is determined whether the nozzle temperature adjustment mode flag x has been set. If the nozzle temperature adjustment mode flag x has not been set (S650=No), S655 and the subsequent steps are skipped.

If the nozzle temperature adjustment mode flag x has been set (S650=Yes), a counter Cr that measures the time for which the nozzle temperature adjustment mode has been continuing starts incrementing. Subsequently, in S660, it is determined whether the value of the counter Cr exceeds a predetermined value Cr1.

If the value of the counter Cr exceeds the predetermined value Cr1 (S660=Yes), the nozzle temperature adjustment mode flag x is reset in S670, the nozzle temperature adjustment mode is canceled in S675, and the counter Cr is reset in S680. If the value of the counter Cr does not exceed the predetermined value Cr1 (S660=No), S670 and the subsequent steps are skipped.

Then, the process proceeds to S695, where this routine is temporarily ended.

According to the process of this specific example, the nozzle temperature may be effectively restrained from exceeding α° C. for an extended period of time. Therefore, it is possible to effectively restrain the acceleration of fixation of deposits to the tip of the fuel injection valve 31 and wearing at the tip of the fuel injection valve 31. Incidentally, a modification as a countermeasure against chemical fixation of deposits will be discussed later.

### Effect Achieved by Configuration of Embodiment

According to this embodiment, the nozzle temperature Tnz may be significantly accurately estimated using various parameters that have been used by the ECU 51 for engine control, even without a nozzle temperature sensor or a special parameter for estimation of the nozzle temperature Tnz.

Thus, the generation state of deposits may be more accurately estimated.

This allows to more favorably perform engine control (fuel injection control in the fuel injection device 3) in order to restrain strong fixation of deposits and deterioration at the tip of the fuel injection valve 31 (such as wearing of the first seat portion 31a1 and the second seat portion 31a2) due to the nozzle temperature Tnz being excessively high. In addition, the precision of fuel injection amount control is favorably maintained.

Moreover, in this embodiment, the nozzle temperature Tnz is estimated using a function of the fuel injection amount Qi [mm³/st], the ignition timing IGT [ATDC], the fuel injection pressure Pi [MPa], and the engine speed NE [rpm]. Thus, it is possible to save actually measuring the nozzle temperature under various engine operating conditions to prepare a nozzle temperature map.

Further, in this embodiment, an operating condition under which the nozzle temperature Tnz is to be lowered is set when the nozzle temperature Tnz continues to be a predetermined level or more for a predetermined time or more. This allows to effectively restrain the acceleration of fixation of deposits to the tip of the fuel injection valve 31 and deterioration at the tip of the fuel injection valve 31.

### List of Modifications

It should be noted that the embodiment and the specific example described above are merely illustrative examples of the present invention. Therefore, the present invention is not limited in any way to the described embodiment.

Thus, various modifications may be made to the embodiment as long as the modifications do not depart from the essence of the present invention.

Hereinafter, several typical modifications will be illustrated. It should be understood that the present invention is not limited to those modifications listed below. In addition, a plurality of modifications may be applied in combination as appropriate without departing from the technical scope of the present invention.

(A) The engine control system 1 may be applied to any type of engine including but not limited to gasoline engines, diesel engines, and methanol engines. The number of cylinders and the arrangement of the cylinders (inline, V, or hyrizontally opposed) are also not specifically limited.

(B) The smoke sensor 52f is most preferably provided in the position most upstream in the flowing direction of the exhaust gas, that is, the position discussed above in the embodiment (the exhaust manifold 45). However, the smoke sensor 52f is not limited to this position. For example, the smoke sensor 52f may be provided between the catalyst filter 47 and the turbine 48b of the turbocharger 48.

(C) To acquire the particle amount Qp, an upstream pressure sensor and a downstream pressure sensor may be used in place of the smoke sensor 52f. Here, the upstream pressure sensor is provided in the exhaust pipe 46 at a location upstream of the catalyst filter 47 in the flowing direction of the exhaust gas. Likewise, the downstream pressure sensor is provided in the exhaust pipe 46 at a location downstream of the catalyst filter 47 in the flowing direction of the exhaust gas.

(D) A throttle position sensor that outputs a signal in accordance with the opening of the throttle valve 44 may be used in place of the load sensor 52n.

(E) In S420, the particle amount Qp may be estimated (or a signal corresponding to an estimation value of the particle amount Qp may be generated) instead of the smoke sensor 52f acquiring the particle amount Qp (or acquiring a signal corresponding to the particle amount Qp).

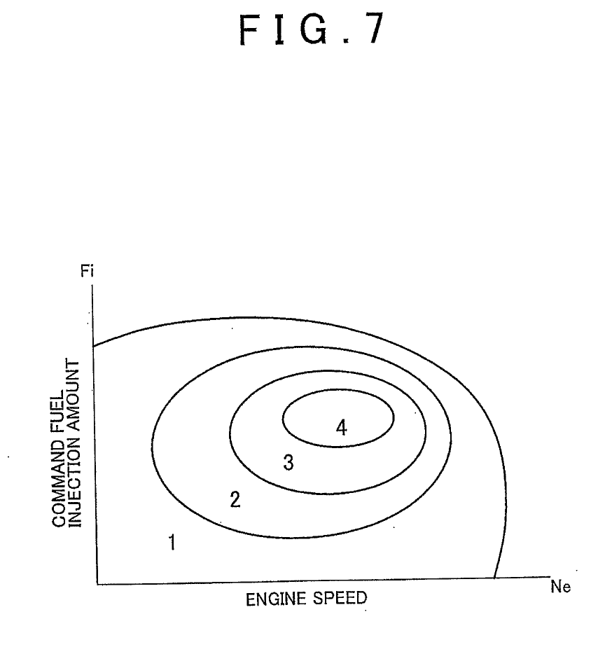

For such estimation, a soot map shown in FIG. 7 may be used, for example. This soot map is stored in the ROM 51c to estimate the state of particles collected at the catalyst filter 47. With the soot map, the particle amount Qp may be estimated based on the actual engine speed NE and the command fuel injection amount Qc.

According to such a configuration, it is not necessary to provide the smoke sensor 52f or use a dedicated map or the like for estimation of the particle amount Qp. Therefore, the device configuration May be simplified, thus reducing the processing burden on the CPU 51a.

It should be noted that the soot map is based on measurement values of the particle generation amount with the engine operating in the steady operation state. Hence, there may occur an error between target values of the intake air flow rate as a result of operation of the accelerator pedal 61 and measurement values of the intake air flow rate Ga based on the output of the airflow meter 52c in actual operation (in particular, in the transient operation state).

Thus, the particle amount Qp obtained using the soot map is preferably corrected with such an error in the intake air flow rate Ga taken into account. This allows the generation state of deposits to be more accurately estimated.

Alternatively, the particle amount Qp may be estimated based on the output of the upstream pressure sensor and the downstream pressure sensor (differential pressure at the catalyst filter 47). That is, the accumulated deposit amount may be estimated based on an estimation value of the amount of soot clogging the catalyst filter 47.

(F) A plurality of different means for acquiring the particle amount Qp may be used at the same time.

In such a configuration, a plurality of momentary adhered deposit amounts and a plurality of accumulated deposit amounts may be obtained based on a plurality of particle amounts Qp. In this case, fuel injection control is preferably performed based on the largest of the plurality of momentary adhered deposit amounts, or the plurality of accumulated deposit amounts.

Alternatively, the momentary deposit adhesion amount or the accumulated deposit amount may be obtained based on the largest one of the plurality of particle amounts Qp.

According to such a configuration, the fuel injection device 3 may be more appropriately controlled. For example, compulsory fuel injection from the second injection hole 31c may be performed at a more appropriate timing. This effectively restrains the adhesion/accumulation of sufficient deposits so as to completely block the second injection hole 31c.

(G) The momentary deposit adhesion amount, and the accumulated deposit amount, may be estimated at every predetermined number of cycles (for example, at every number of cycles an integer times the number of cylinders) or at predetermined intervals, instead of at every cycle (at predetermined crank angle).

For example, if the smoke sensor 52f is used to actually measure the particle amount Qp and the momentary adhered deposit amount and the accumulated deposit amount are acquired or estimated based on the actually measured particle amount Qp, the acquired or estimated value of the momentary adhered deposit amount is considered to be relatively correct. Therefore, in this case, the momentary adhered deposit amount and the accumulated deposit amount are preferably estimated at every cycle (at every predetermined crank angle).

In contrast, if the soot map is used but the intake air flow rate is not corrected, or if the differential pressure at the catalyst filter 47 is used, for example, the momentary deposit adhesion amount and the accumulated deposit amount may be estimated at every predetermined number of cycles (for example, at every number of cycles an integer times the number of cylinders) or at every predetermined time, which provides higher precision, instead of at every cycle (at every predetermined crank angle), to estimate the momentary deposit adhesion amount and the accumulated deposit amount accurately.

(H) The adhered/accumulated deposit amount at the first injection hole 31b also may be acquired or estimated in the same way. That is, when the particle amount is large, the adhesion/accumulation of deposits at the first injection hole 31b is promoted, which is generally the same as the case of the second injection hole 31c discussed above. Therefore, the present invention may be favorably applied also to a fuel injection device 3 including a fuel injection valve 31 having no second injection hole 31c.

(I) The parameters used in the respective processes discussed above may be appropriately changed.

For example, the required engine speed N and the actual engine speed NE may be interchanged with each other. Moreover, a parameter other than the common rail pressure Pcr may be used as the fuel injection pressure Pi.

As the fuel injection amount Qi, in place of the target fuel injection amount Qt, the command fuel injection amount Qc (obtained by subjecting the target fuel injection amount to a correction based on the output of an air-fuel ratio sensor or the like) may be used. Alternatively, the fuel injection amount Qi may be obtained based on the amount of decrease in the common rail pressure Pcr.

Still alternatively, an individual injection amount at each injection timing, such as the main injection amount Qmain, may be used as the fuel injection amount Qi.

(J) To estimate the nozzle temperature Tnz, the intake air flow rate Ga or the EGR rate EGRR may be used. These parameters influence the ignition timing IGT.

(K) The ignition timing IGT may be acquired (actually measured or estimated) in various ways other than discussed above in the specific example.

For example, the ignition timing IGT may be detected by the in-cylinder pressure sensor 52e (combustion pressure sensor). Alternatively, the ignition timing IGT may be estimated using a known ignition timing map. An example of this ignition timing map uses as parameters the engine speed NE and the engine load L which is based on the operation amount Accp of the accelerator pedal 61, and another uses as parameters the engine speed NE and the fuel injection amount Qi.

Moreover, for plug-ignition engines, the ignition timing IGT may be specified by a plug ignition timing Tign.

(L) The present invention does not exclude the use of a nozzle temperature map. The engine speed NE and the fuel injection amount Qi may be used as parameters of the nozzle temperature map, for example.

(M) The nozzle temperature adjustment process that reduces the acceleration of fixation (chemical, strong adhesion) of deposits to the tip of the fuel injection valve 31 and the nozzle temperature adjustment process that reduces the acceleration of deterioration at the tip of the fuel injection valve 31 (such as wearing of the first seat portion 31a1 and the second seat portion 31a2 due to being softened by tempering as a result of being overheated) may be individually performed.

That is, in the flowchart of FIG. 6, different processes may be performed between the case where the nozzle temperature Tnz remains above α1 for a predetermined period and the case where the nozzle temperature Tnz remains above α2 for a predetermined period.

Here, the temperature α1 is a criterion value of the nozzle temperature Tnz to restrain wearing at the tip of the fuel injection valve 31. Meanwhile, the temperature α2 is a criterion value of the nozzle temperature Tnz to restrain chemical fixation of deposits.

In the former case, the process is performed as described above in the specific example. In the latter case, the ignition timing IGT is delayed, and the fuel injection pressure Pi is increased to to minimize the increase in the amount of deposits generated.

Here, when the fuel injection pressure Pi is increased, the nozzle temperature Tnz tends to rise. However, as discussed above, the influence of a decrease in the fuel injection amount Qi or a delay in the ignition timing IGT on the nozzle temperature Tnz, which lowers it, is greater than the influence of the fuel injection pressure Pi on the nozzle temperature Tnz, which raises it.

Therefore, even if the fuel injection pressure Pi is increased to reduce the increase in the amount of deposit generated, it is possible to favorably remove deposit while minimizing increases in the nozzle temperature Tnz by delaying the ignition timing IGT and so forth at the same time, to which the nozzle temperature Tnz is more sensitive.

(N) The configuration of the present invention may be applied to various operational controls of the engine control system 1 (fuel injection device 3). For example, the configuration of the present invention may be applied to not only the process against the generation of deposits at, or against the wearing of, the tip of the fuel injection valve 31 (compulsory fuel injection control or nozzle temperature control), but also the case of correcting the fuel injection amount (acquiring a correction amount with which the target fuel injection amount Qt is corrected to obtain the command fuel injection amount Qc).

(O) It should be understood that other modifications not specifically mentioned may also fall within the scope of the present invention as long as they do not depart from the essence of the present invention. Of the components constituting the means for solving the problem of the present invention, the components described in terms of their effects and functions may include any structure to achieve those effects and functions, in addition to the specific structures described in the embodiment and the modifications described above.

1.-10. (canceled)

11. A control device for an internal combustion engine including a fuel injection device that injects fuel into a combustion chamber from an injection hole provided at a tip of a fuel injection valve, the control device comprising:
a first parameter acquisition section that acquires a first parameter that indicates a combustion temperature when fuel is combusted in the combustion chamber;
a second parameter acquisition section that acquires a second parameter that indicates a heat exposure timing at which the tip of the fuel injection valve is exposed to heat produced by the combustion of the fuel and a heat exposure time for which the tip of the fuel injection valve is exposed to the heat produced by the combustion of the fuel;
a third parameter acquisition section that acquires a third parameter that indicates a temperature increase of the fuel along with a decrease in pressure of the fuel at the injection hole; and
a temperature estimation section that estimates a temperature at the tip of the fuel injection valve based on the first to third parameters.

12. The control device according to claim 11, wherein the first parameter acquisition section acquires a fuel injection amount and a combustion timing as the first parameter.

13. The control device according to claim 12, wherein the first parameter acquisition section acquires as the first parameter at least one of an engine speed, a fuel injection amount, an intake air temperature, an engine coolant temperature, a fuel injection pressure, a fuel injection timing, an in-cylinder oxygen concentration, and a charging pressure, which indicate each a parameter corresponding to the combustion timing.

14. The control device according to claim 11, wherein the second parameter acquisition section acquires an engine speed and a combustion timing as the second parameter.

15. The control device according to claim 14, wherein the second parameter acquisition section acquires as the second parameter at least one of an engine speed, a fuel injection amount, an intake air temperature, an engine coolant temperature, a fuel injection pressure, a fuel injection timing, an in-cylinder oxygen concentration, and a charging pressure, which indicate each a parameter corresponding to the combustion timing.

16. The control device according to claim 11, wherein the third parameter acquisition section acquires a pressure of the fuel in the fuel injection device as the third parameter.

17. The control device according to claim 11, wherein a condition for injection of the fuel is controlled such that the temperature at the tip of the fuel injection valve is lowered when an estimated temperature obtained by the temperature estimation section remains at a predetermined temperature or more for at least a predetermined time.

18. The control device according to claim 11, wherein the fuel injection amount, the combustion timing, the fuel injection pressure, and the engine speed are acquired as at least one of the first to third parameters, and the temperature estimation section estimates the temperature at the tip of the fuel injection valve based on a function of the fuel injection amount, the combustion timing, the fuel injection pressure, and the engine speed.

19. The control device according to claim 18, wherein the function is represented as Tnz=C1·NE+C2·Qi+C3·IGT+C4·Pi, where Tnz represents the temperature at the tip of the fuel injection valve, NE represents the engine speed, Qi represents the fuel injection amount, IGT represents the combustion timing, Pi represents the fuel injection pressure, and C1 to C4 each represents a constant different according to engine specifications.

20. A control method for an internal combustion engine including a fuel injection device that injects fuel into a combustion chamber from an injection hole provided at a tip of a fuel injection valve, the control method comprising:
acquiring a first parameter that indicates a combustion temperature when the fuel is combusted in the combustion chamber;
acquiring a second parameter that indicates a heat exposure timing at which the tip of the fuel injection valve is exposed to heat produced by the combustion of the fuel and a heat exposure time for which the tip of the fuel injection valve is exposed to the heat produced by the combustion of the fuel;
acquiring a third parameter that indicates a temperature increase of the fuel along with a decrease in pressure of the fuel at the injection hole; and
estimating a temperature at the tip of the fuel injection valve based on the first to third parameters.
